(19) United States
(12) Patent Application Publication
(10) Pub. No.: US 2016/0093851 A1
(43) Pub. Date: Mar. 31, 2016

(54) BATTERY MODULE WITH INDIVIDUALLY RESTRAINED BATTERY CELLS

(71) Applicant: Johnson Controls Technology Company, Holland, MI (US)

(72) Inventors: Jonathan P. Lobert, Hartford, WI (US); Jason D. Fuhr, Sussex, WI (US); Robert J. Mack, Milwaukee, WI (US); Richard M. DeKeuster, Racine, WI (US)

(21) Appl. No.: 14/501,989

(22) Filed: Sep. 30, 2014

(51) Int. Cl. H01M 2/10; H01M 4/131; H01M 10/0587; H01M 10/0525; H01M 2/20

(52) U.S. Cl. CPC H01M 2/1077; H01M 10/0525; H01M 2/206; H01M 10/0587; H01M 4/131; H01M 2220/20

(57) ABSTRACT

The present disclosure includes a battery module that includes a plurality of lithium ion battery cells disposed within a battery module packaging. Each of the plurality of lithium ion battery cells is individually held in place within the battery module packaging by a restraining medium. The restraining medium conformally covers a substantial portion of the surface of each of the plurality of lithium ion battery cells and prevents each of the plurality of lithium ion battery cells from expanding during operation of the battery module.

### BACKGROUND

The present disclosure relates generally to the field of batteries and battery modules. More specifically, the present disclosure relates methods for individually restraining battery cells within battery modules.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 volt or 130 volt systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles. For example, in traditional configurations, the battery cells of a battery module are usually tightly packed within the battery module packaging in order to maximize energy density of the battery module. As such, the thickness of each battery cell should be substantially uniform for such traditional configurations, and even differences in the thicknesses of battery cells that result from manufacturing variability can prove problematic when attempting to position the battery cells within the packaging of a battery module. Accordingly, it is presently recognized that battery designs may be improved to provide improved mechanisms for retaining the battery cells within the battery module that enable greater flexibility in the dimensions of each battery cell.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a battery module that includes a plurality of lithium ion battery cells disposed within a battery module packaging. Each of the plurality of lithium ion battery cells is individually held in place within the battery module packaging by a restraining medium. The restraining medium conformally covers a substantial portion of the surface of each of the plurality of lithium ion battery cells and prevents each of the plurality of lithium ion battery cells from expanding during operation of the battery module.

The present disclosure also relates to a method of manufacturing a battery module that includes coupling a plurality of battery cells to at least one bus bar assembly and disposing at least one restraining medium precursor inside of a battery module packaging. The method further includes disposing the plurality of battery cells and the at least one bus bar assembly into the at least one restraining medium precursor inside the battery module packaging and curing the at least one restraining medium precursor to form a restraining medium that holds the plurality of battery cells in position within the battery module packaging.

The present disclosure also relates to a method of manufacturing a battery module that includes disposing at least one restraining medium precursor inside of a battery module packaging and disposing a plurality of battery cells into the at least one restraining medium precursor inside the battery module packaging. The method further includes coupling the plurality of battery cells to at least one bus bar assembly and curing the at least one restraining medium precursor to form a restraining medium that holds the plurality of battery cells in position within the battery module packaging.

### DRAWINGS

Various aspects of this disclosure may be better understood upon reading the following detailed description and upon reference to the drawings in which:

FIG. 1 is a perspective view of a vehicle having a battery module configured in accordance with present embodiments to provide power for various components of the vehicle;

FIG. 2 is a cutaway schematic view of an embodiment of the vehicle and the battery module of FIG. 1;

FIG. 3 is a perspective view of an embodiment of a prismatic battery cell for use in a battery module of the present approach;

FIG. 4 is a perspective view of an embodiment of a power assembly of a battery module of the present approach;

FIG. 5 is a top perspective view of a portion of an embodiment of a battery module of the present approach;

FIG. 6 is schematic cross-sectional view of an embodiment of a battery module of the present approach;

FIG. 7 is a flow diagram illustrating an embodiment of a method for manufacturing a battery module of the present approach; and

FIG. 8 is a flow diagram illustrating another embodiment of a method for manufacturing a battery module of the present approach.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The battery systems described herein may be used to provide power to various types of electric vehicles (xEVs) and other high voltage energy storage/expending applications (e.g., electrical grid power storage systems). Such battery systems may include one or more battery modules, each battery module having a number of prismatic battery cells (e.g., Lithium-ion (Li-ion) electrochemical cells) arranged to provide particular voltages and/or currents useful to power, for example, one or more components of an xEV.

The battery cells may have a variety of shapes and sizes, and the present disclosure is intended to generally apply to all of these variations as appropriate. However, as set forth above, certain types of battery cells having particular shapes, such as prismatic battery cells, may be subject to swelling and variations within a particular manufacturing tolerance. Unfortunately, such swelling and variations can result in a wide variation in size (e.g., thickness), even though the battery cells in a particular set of cells are within a manufacturing tolerance of one another and are the same type of battery cell.

It is now recognized that these variations can be problematic for certain techniques involved with battery module manufacturing, such as establishing a substantially uniform energy density for a set of battery modules, and also with establishing battery cell electrical interconnections using bus bars. For instance, as the thickness of battery cells change, so may the distance between their respective terminals. Accordingly, establishing certain manufacturing specifications, such as distances between battery cell terminals, can be a challenge.

In addition, because of the potential variations in size, actuatable clamping mechanisms such as a clamp attached to the battery module, a movable plate disposed within the battery module housing that may be actuated (e.g., using a crank, a clamp, an adjustable tie and bolt mechanism) to abut against the battery cells, or an adjustable tie and bolt mechanism used to actuate components (e.g., outer or inner walls) of the battery module housing, may be used to compress the battery cells by a particular amount. This may be done to maintain the energy density and performance of the battery cells within a predetermined range. Prismatic battery cells, for example, are traditionally held in place by such actuatable clamping mechanisms that are a part of or integrated with a battery module housing.

In view of the foregoing considerations, among others, in traditional manufacturing processes, each prismatic battery cell is carefully selected to ensure that the battery cells will fit and be tightly packed within the packaging of the battery module. However, unlike the battery cells of other battery modules, the present embodiments include battery module designs where battery cells are individually restrained within a conformal restraining medium at the time of manufacturing. By individually restraining the battery cells into position within the battery module packaging, the disclosed designs enable greater variability in the dimensions of each battery cell of a battery module, providing greater flexibility to select a set of battery cells for installation in a battery module based on particular electrical and thermal considerations, without having to worry about the exact dimensions of each battery cell relative to battery module packaging. Additionally, the disclosed restraining medium individually prevents each of the battery cells from substantially swelling during operation (e.g., swelling beyond a predetermined amount), improving performance of the battery cells over the lifetime of the battery module. In general, the disclosed restraining media may be electrically insulating to prevent current leakages between the battery cells and may be thermally conductive to promote battery cell cooling during operation. Additionally, in certain embodiments, the restraining medium may also provide advantages by acting as a sink for heat and/or gases released during a thermal runaway event.

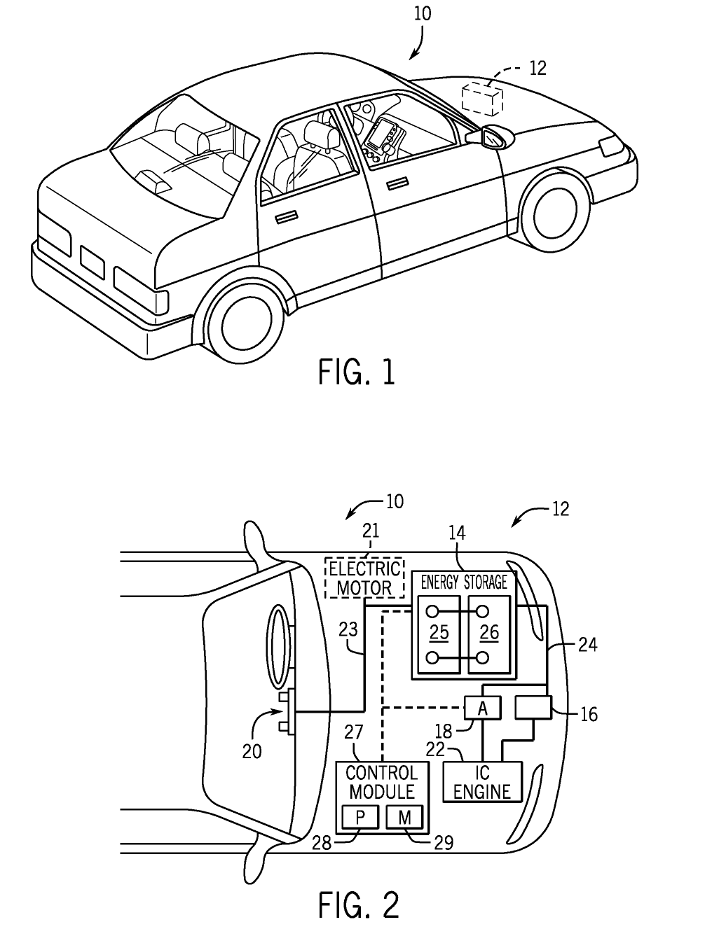

With the foregoing in mind, present embodiments relating to individually restrained battery cells and associated features may be applied in any number of energy expending systems (e.g., vehicular contexts and stationary power contexts). To facilitate discussion, embodiments of the battery modules described herein are presented in the context of advanced battery modules (e.g., Li-ion battery modules) employed in xEVs. To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 21. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 14 supplies power to the vehicle console 20 and the ignition system 16, which may be used to start (e.g., crank) the internal combustion engine 22.

Additionally, the energy storage component 14 may capture electrical energy generated by the alternator 18 and/or the electric motor 21. In some embodiments, the alternator 18 may generate electrical energy while the internal combustion engine 22 is running More specifically, the alternator 18 may convert the mechanical energy produced by the rotation of the internal combustion engine 22 into electrical energy. Additionally or alternatively, when the vehicle 10 includes an electric motor 21, the electric motor 21 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 21 during regenerative braking. As such, the alternator and/or the electric motor 21 are generally referred to herein as a regenerative braking system.

To facilitate capturing and supplying electric energy, the energy storage component 14 may be electrically coupled to the vehicle's electric system via a bus 24. For example, the bus 24 may enable the energy storage component 14 to receive electrical energy generated by the alternator 18 and/or the electric motor 21. Additionally, the bus may enable the energy storage component 14 to output electrical energy to the ignition system 16 and/or the vehicle console 20. Accordingly, when a 12 volt battery system 12 is used, the bus 24 may carry electrical power typically between 8-18 volts.

Additionally, as depicted, the energy storage component 14 may include multiple battery modules. For example, in the depicted embodiment, the energy storage component 14 includes a lithium ion (e.g., a first) battery module 25 and a lead-acid (e.g., a second) battery module 26, which each includes one or more battery cells. In other embodiments, the energy storage component 14 may include any number of battery modules. Additionally, although the lithium ion battery module 25 and lead-acid battery module 26 are depicted adjacent to one another, they may be positioned in different areas around the vehicle. For example, the lead-acid battery module 26 may be positioned in or about the interior of the vehicle 10 while the lithium ion battery module 25 may be positioned under the hood of the vehicle 10.

In some embodiments, the energy storage component 14 may include multiple battery modules to utilize multiple different battery chemistries. For example, when the lithium ion battery module 25 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 27. More specifically, the control module 27 may control operations of components in the battery system 12, such as relays (e.g., switches) within energy storage component 14, the alternator 18, and/or the electric motor 21. For example, the control module 27 may regulate amount of electrical energy captured/supplied by each battery module 25 or 26 (e.g., to de-rate and re-rate the battery system 12), perform load balancing between the battery modules 25 and 26, determine a state of charge of each battery module 25 or 26, determine temperature of each battery module 25 or 26, control voltage output by the alternator 18 and/or the electric motor 21, and the like.

Accordingly, the control module 27 may include one or processor 28 and one or more memory 29. More specifically, the one or more processor 28 may include one or more application specific integrated circuits (ASICs), one or more field programmable gate arrays (FPGAs), one or more general purpose processors, or any combination thereof. Additionally, the one or more memory 29 may include volatile memory, such as random access memory (RAM), and/or non-volatile memory, such as read-only memory (ROM), optical drives, hard disc drives, or solid-state drives. In some embodiments, the control module 27 may include portions of a vehicle control unit (VCU) and/or a separate battery control module. Furthermore, as depicted, the lithium ion battery module 25 and the lead-acid battery module 26 are connected in parallel across their terminals. In other words, the lithium ion battery module 25 and the lead-acid module 26 may be coupled in parallel to the vehicle's electrical system via the bus 24.

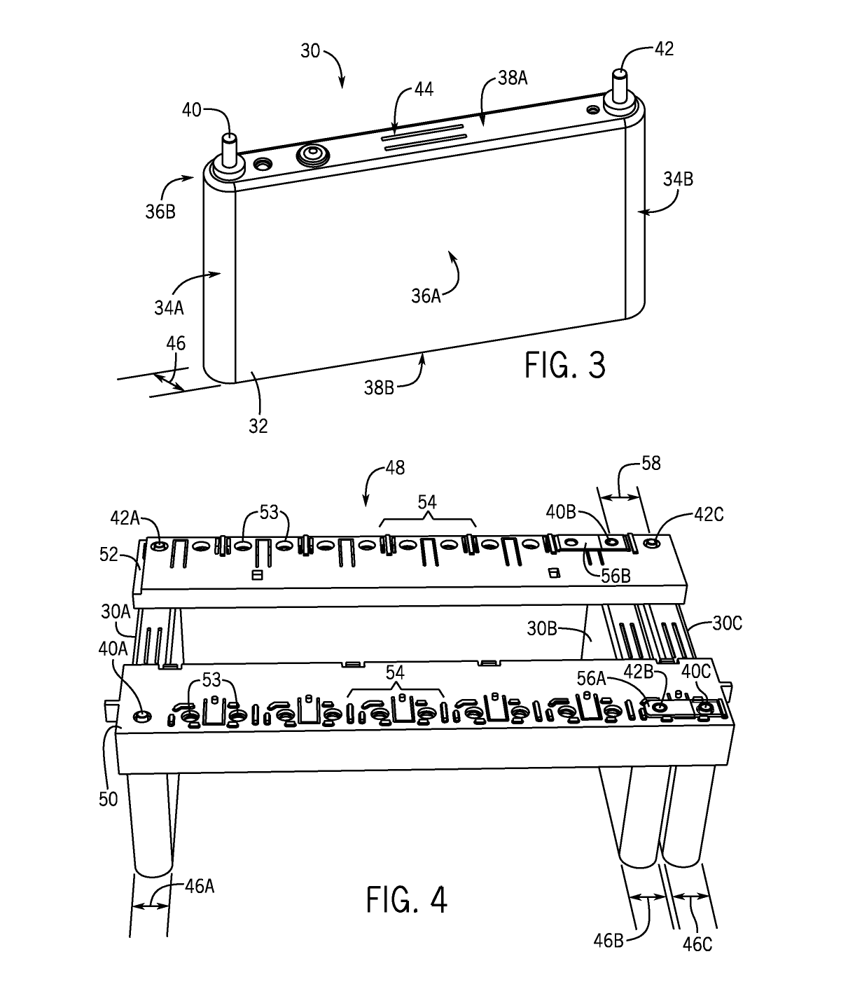

The lithium ion battery modules 25 described herein, as noted, may include a number of lithium ion electrochemical battery cells electrically coupled to provide particular currents and/or voltages to provide power to the xEV 10. FIG. 3 is a perspective view of an embodiment of a battery cell 30, in particular a prismatic battery cell, that may be used with the presently disclosed battery module designs. Again, other battery cells shapes and designs may be incorporated into other similarly-configured battery modules. The illustrated battery cell 30 has a packaging 32 (e.g., a metallic “casing” or “can”) that encloses the internal components of the cell, including the “jelly-roll” of the cathode and anode materials and a suitable electrolyte. The battery cell 30 may be any suitable type of lithium ion electrochemical cell, including but not limited to lithium nickel manganese cobalt oxide (NMC) and lithium titanate (LTO) battery cells, NMC/graphite battery cells, and so forth. By way of example, the positive electrode (cathode) active material and/or the negative electrode (anode) active material may be a lithium metal oxide (LMO) component or a blend of multiple LMO components. As used herein, lithium metal oxides (LMOs) may refer to any class of materials whose formula includes lithium and oxygen as well as one or more additional metal species (e.g., nickel, cobalt, manganese, aluminum, iron, or another suitable metal). A non-limiting list of example LMOs may include: mixed metal compositions including lithium, nickel, manganese, and cobalt ions such as lithium nickel cobalt manganese oxide (NMC) (e.g., LiNi_{1/3}Co_{1/3}Mn_{1/3}O₂), lithium nickel cobalt aluminum oxide (NCA) (e.g., LiNi_{0.8}Co_{0.15}Al_{0.05}O₂), lithium cobalt oxide (LCO) (e.g., LiCoO₂), and lithium metal oxide spinel (LMO-spinel) (e.g., LiMn₂O₄). By specific example, in certain embodiments, the positive electrode (cathode) active material may be a NMC/LCO blend and the negative electrode (anode) active material may be LTO for the illustrated battery cell 30. In other embodiments, the positive electrode (cathode) active material may be a LTO blend and the negative electrode (anode) active material may be graphite for the illustrated battery cell 30. However, it may be appreciated that the present disclosure is not intended to be limited to a particular combination of cathode and anode active materials and, indeed, is intended to be compatible with any appropriate combination of active materials. Additionally, the packaging or case 32 of the illustrated prismatic battery cell 30 has no substantial polarity (i.e., a neutral can); however, in other embodiments, the packaging 32 may have a positive or negative polarity.

The battery cell 30 illustrated in FIG. 3 is prismatic, where a prismatic battery cell, as defined herein, includes a prismatic case that is generally rectangular in shape. In contrast to pouch cells, the prismatic casing is formed from a relatively inflexible, hard (e.g., metallic) material. However, it should be noted that certain of the embodiments described below may incorporate pouch cells and/or cylindrical cells in addition to or in lieu of prismatic battery cells.

The packaging 32 of the illustrated prismatic battery cell 30 includes rounded end portions 34A and 34B as well as substantially flat front and back sides 36A and 36B. In accordance with present embodiments, each prismatic battery cell 30 may include a top portion 38A, where a set of cell terminals 40, 42 (e.g., positive and negative cell terminals) are located. One or more cell vents 44 may also be located on the top portion 38A. The packaging 32 of the illustrated prismatic battery cell 30 also includes a bottom portion 38B positioned opposite the top portion 38A. First and second end portions 34A and 34B, which may be straight or rounded, extend between the bottom and top casing portions 38A, 38B in respective positions corresponding to the cell terminals 40, 42. First and second sides 36A, 36B, which may be flat (as shown) or rounded, couple the first and second end portions 34A, 34B at opposing ends of the packaging 32 of the illustrated prismatic battery cell 30.

It may be appreciated that, in certain embodiments, the illustrated prismatic battery cell 30 may swell or expand during operation. For example, for embodiments in which the prismatic battery cell 30 is lithium ion battery cell having a graphitic anode active material, the layers of the “jelly-roll” disposed within the packaging 32 of the prismatic battery cell 30 may expand as a result of Li intercalation during charging. Additionally, in certain embodiments, the prismatic battery cell 30 may also expand as a result of resistive heating when charging. As such, for certain embodiments, if the packaging 32 of the prismatic battery cell 30 is not properly restrained, then the packaging 32 may bulge and swell as a result of the expansion of the internal components of the cell. This reduces energy density and performance of the battery cell 30. Additionally, as the prismatic battery cell 30 swells, the individual cathode and anode layers of the “jelly-roll” may be allowed to separate from one another, increasing the resistance of the battery cell 30. As such, it is generally desirable to restrain the prismatic battery cell 30 in such a manner that the packaging 32 is not able to substantially swell or expand during charging cycles in order to improve the performance and the longevity of the prismatic battery cell 30.

In other battery modules, a number of prismatic battery cells, like the prismatic battery cell 30 illustrated in FIG. 3, may be packed tightly against one another such that each prismatic battery cell 30 is restrained against its neighbor or against heat fins or shelves to restrict the expansion of the battery cells during charging cycles. For battery modules in which the prismatic battery cells 30 are restrained by being tightly packed together, each prismatic battery cell 30 of the battery module must be carefully selected so that each prismatic battery cell 30 fits into its respective position (e.g., on or between particular heat fins or shelves) and/or that all of the prismatic battery cells 30 of the battery module fit within the packaging of the battery module. By specific example, for other battery modules, each prismatic battery cell 30 of a battery module being manufactured may be carefully selected from a lot of prismatic battery cells 30 such that the thickness 46 of each prismatic battery cell 30 together matches the width of the packaging of the battery module to ensure tight packing. It may be appreciated that, within a lot (a set) of prismatic battery cells 30, the thicknesses 46 may vary from cell to cell because of manufacturing variability and because the prismatic battery cells 30 may not have identical states of charge (SOC). As such, when other battery modules are assembled, the dimensions of each prismatic battery cell 30 are a major design consideration that should be met before other design considerations of the prismatic battery cells 30 (e.g., electrical and thermal considerations) may be addressed.

Accordingly, present embodiments address the limitations of other battery modules by individually restraining each prismatic battery cell 30 in a restraining medium such that the manufacturer no longer needs to be concerned about slight variations in the thickness 46 of each prismatic battery cell 30 and may have greater flexibility to focus on selecting the prismatic battery cells 30 of a battery module 12 based on other (e.g., electrical, thermal) design considerations.

As used herein, the distance between the center of a terminal of one prismatic battery cell 30 and the center of the closest terminal of an adjacent prismatic battery cell 30 may be referred to as the “cell-to-cell distance.” For battery module designs that use a tightly packed stack of prismatic battery cells 30, the cell-to-cell distance is affected by the thickness 46 of each prismatic battery cell 30. However, for the disclosed battery module designs, the cell-to-cell distance is set at the time of manufacturing by the bus bar assemblies that couple the prismatic battery cells 30 of the battery module 12 to one another.

For example, FIG. 4 is a perspective view illustrating an embodiment of a power assembly 48 of a battery module. The illustrated power assembly 48 includes three prismatic battery cells 30A, 30B, and 30C that are coupled to one another via a first (e.g., front) bus bar assembly 50 and a second (e.g., back) bus bar assembly 52. It may be appreciated that the illustrated power assembly 48 is not complete as ten additional prismatic battery cells 30 have been removed to more clearly view other elements. As shown by prismatic battery cells 30B and 30C, each prismatic battery cell 30 may be oriented electrically opposite the adjacent prismatic battery cell 30, such that the negative terminal 42C of the prismatic battery cell 30C is disposed near the positive terminal 40B of the neighboring prismatic battery cell 30B. Each of the positive terminals 40A, 40B, and 40C and the negative terminals 42A, 42B, and 42C extend up through holes 53 in the first and second bus bar assemblies 50 and 52. Additionally, the first and second bus bar assemblies 50 and 52 each include a number of slots 54 that each receive a bus bar 56 (e.g., bus bars 56A and 56B) that electrically couple the positive terminal of one prismatic battery cell (e.g., the positive terminal 40C of the prismatic battery cell 30C) to the negative terminal of an adjacent prismatic battery cell (e.g., the negative terminal 42B of the prismatic battery cell 30B). Once fully assembled, each of the terminals of the prismatic battery cells 30 of the power assembly 48 would be coupled to one of the bus bars 54, except for the first and last terminals (e.g., terminals 40A and the 42C), which may be electrically coupled other portions (e.g., a master relay, power conversion circuitry) of the battery module.

In certain embodiments, the bus bar assemblies 50 and 52 may be polymeric and the bus bars 54 may be monometallic or bimetallic. That is, for embodiments in which the prismatic battery cells 30 include an embodiment of the positive terminal 40 made from a first metal (e.g., aluminum) and an embodiment of the negative terminal 42 made from a second metal (e.g., copper), a portion of each bus bar 54 may be made from the first metal (e.g., aluminum) and another portion may be made from the second metal (e.g., copper) to enable effective laser welding and mitigate galvanic effects. By specific example, in certain embodiments, except for the first and last terminals 40A and 42C of the power assembly 48, the aluminum positive terminals 40 of each prismatic battery cell 30 may be coupled (e.g., laser welded) to the aluminum portion of the bus bars 54 and the copper negative terminals 42 of each prismatic battery cell 30 may be coupled (e.g., laser welded) to the copper portion of the bus bars 54. In other embodiments, the prismatic battery cells 30 may be coupled to the bus bars 54 of the bus bar assemblies 50 and 52 using adhesive, fasteners, clamps, clips, press fitting, or other suitable methods of coupling. In other embodiments, the terminals 40 and 42 of the prismatic battery cells 30 may be made from the same metal (e.g., aluminum), and the bus bars 54 may similarly be made entirely from the same metal (e.g., aluminum).

As illustrated in FIG. 4, the bus bar assemblies 50 and 52 define the cell-to-cell distance 58. That is, as illustrated in FIG. 4, the prismatic battery cells 30B and 30C are not pressed directly against one another, but rather, the distance 58 between the prismatic battery cells 30B and 30C is defined or controlled by the spacing between the holes 53 through which the terminals 40B, 42B, 40C, 42C extend and by the dimensions of the bus bar 56A that electrically couples the two cells. As such, the cell-to-cell distance 58 is not defined or controlled by the thicknesses 46B and 46C of the prismatic battery cells 30B and 30C. It may be appreciated that, in certain embodiments, the bus bar assemblies 50 and 52 may enable a suitable cell-to-cell spacing 58 such that prismatic battery cells 30 having substantially varying thicknesses 46 may be accommodated and coupled to the bus bar assemblies 50 and 52.

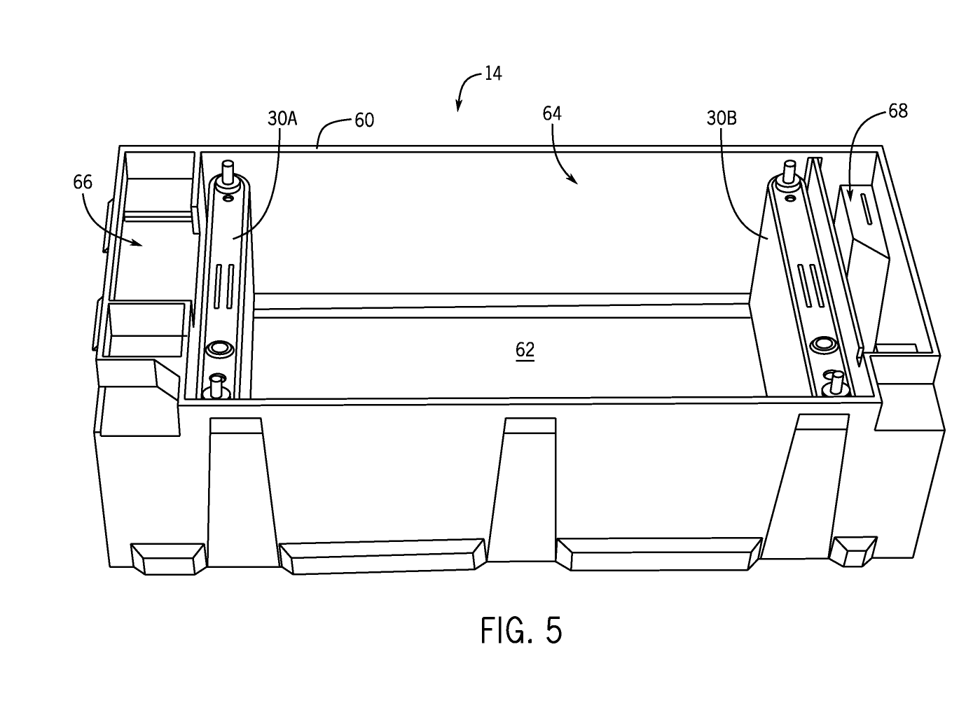

FIG. 5 is a schematic of a portion of an embodiment of the battery module 14, such as may be incorporated into the battery system 12 discussed above or used as a standalone module in a micro-hybrid xEV (e.g., in combination with a lead-acid battery). In particular, the illustrated portion of the battery module 14 includes a battery module packaging 60 (e.g., a lower housing portion) having two prismatic battery cells 30A and 30B positioned within, resting on a bottom 64 of a power assembly compartment 64 of the packaging 60. In certain embodiments, the packaging 60 of the battery module 14 may be polymeric or metallic. It may be noted that the battery module 14 illustrated in FIG. 5 has a number of prismatic battery cells 30 that are absent to provide a clear view of the packaging 60. The illustrated battery module 14 also includes other compartments, including compartments 66 and 68, for other components (e.g., relays, control circuitry) of the battery module 14.

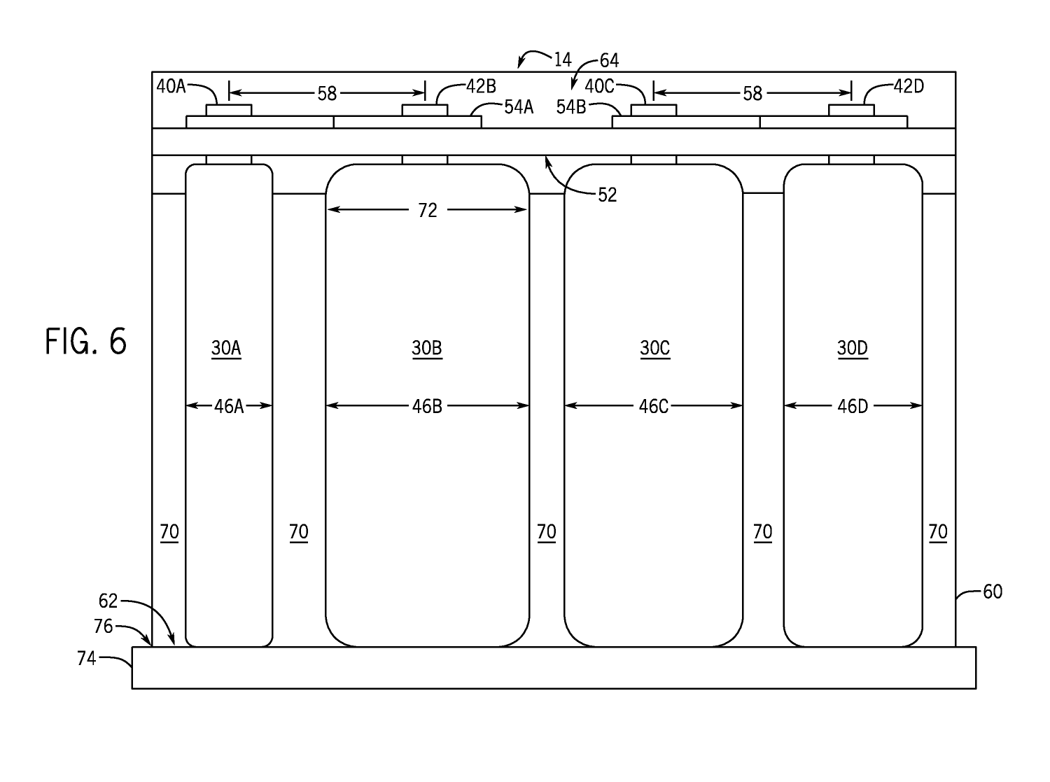

As mentioned above, present embodiments are directed toward individually restraining prismatic battery cells within a restraining medium. Methods of manufacturing battery modules of the present approach are discussed in greater detail below. FIG. 6 is a schematic cross-sectional view illustrating a portion of the fully assembled battery module 14 having a number of prismatic battery cells 30A, 30B, 30C, and 30D, each individually restrained within a restraining medium 70. Each of the illustrated prismatic battery cells 30A, 30B, 30C, and 30D has a different respective thickness 46A, 46B, 46C, and 46D, and the difference between these thicknesses is exaggerated for the purpose of discussion. Each of the illustrated prismatic battery cells 30A-D rests on the bottom 62 of the power assembly compartment 64 of the battery module 14 and is coupled to the bus bar assembly 52. More specifically, the illustrated prismatic battery cells 30A-D are electrically coupled to an adjacent battery cell via the bus bars 54A and 54B, as described above. Accordingly, as mentioned above, the cell-to-cell spacing 58 is defined or controlled by the positions of the holes in the bus bar assembly 52, as well as the dimensions of the bus bars 54A and 54B, through which the terminals 40A, 42B, 40C, and 42D extend. Thus, the cell-to-cell spacing 58 is substantially uniform and is not altered or affected by the varying thicknesses 46A, 46B, 46C, and 46D of the prismatic battery cells 30A, 30B, 30C, and 30D.

In general, the restraining medium 70 may meet one or more design considerations. The restraining medium 70 may be sufficiently solid and have sufficient physical properties to hold the prismatic battery cells 30 into position within the packaging 60 of the battery module 14. The restraining medium 70 may have sufficient hardness (e.g., a high Shore durometer hardness or high modulus) to resist (e.g., block or prevent) the expansion or swelling (e.g., increases in the thicknesses 46A-D) of the prismatic battery cells 30 during charging cycles. As an example, the restraining medium may have a Shore hardness value on an appropriate scale (e.g., OO, A, D) in accordance with ASTM D2240 that is higher than, for example, foams (e.g., closed cell foams), and other polymers or similar materials considered to be of similar physical properties. Indeed, such materials may be insufficient to act as a restraining medium in accordance with present embodiments (e.g., prevent/reduce/mitigate swelling).

The restraining medium 70 (its precursor) may be substantially conformal in order to conform to the shapes of the prismatic battery cells 30A-D and the shape of the power assembly compartment 64 of the battery module packaging 60. It may be appreciated that, by conforming around the shape of each prismatic battery cell 30, a conformal restraining medium 70 provides more uniform contact around each prismatic battery cell 30 despite the defects, imperfections, or manufacturing variability of each prismatic battery cell 30. It will be appreciated that the use of the terms “conformal” and “conformally coated” should not be confused with a flexible and conformable material. Rather, the conformal nature of the restraining medium 70, as used herein, is intended to denote the ability of the restraining medium 70 to be conformed about the battery cells 30 before it is set, so that the restraining medium 70 is, in a sense, molded about the battery cells 30.

Additionally, the restraining medium 70 may contact a substantial portion of the surface of the prismatic battery cells 30. For example, in certain embodiments, the restraining medium 70 may contact more than 70%, 75%, 80%, 85%, 90%, or 95% of the surface area of the prismatic battery cells 30. In certain embodiments, the restraining medium 70 may contact every side or face of the packaging 32 of the prismatic battery cells 30 except the side of the packaging 32 that includes the vent feature 44 (e.g., contact sides 36A, 36B, 34A, 34B, 38B, but not side 38A, as illustrated in FIG. 3) and terminals 40, 42. In certain embodiments, the prismatic battery cells 30 may be disposed within the restraining medium 70 such that the restraining medium 70 disposed on the outside of the battery cells 30 is approximately the same height (or other position) and overlaps with the “jelly-roll” disposed inside each of the battery cells 30, which corresponds to the region of the prismatic battery cells 30 where they are most likely to expand during use. The level corresponding to the roll, for example where overlap may be desired, is shown schematically in prismatic battery cell 30B as arrow 72.

In certain embodiments, the restraining medium 70 may be electrically insulating, especially when the packaging 32 of the prismatic battery cells 30 has a positive or negative polarity; however, an electrically insulating restraining medium 70 may still be useful to limit leakage currents between prismatic battery cells 30 having neutral packaging 32. In certain embodiments, the restraining medium 70 may be thermally conductive. In particular, in certain embodiments, the restraining medium 70 may provide a thermally conductive pathway between the prismatic battery cells 30 and the bottom 64 of the battery module packaging 60, which may enable a heat sink 74 disposed against a bottom outer surface 76 of the battery module packaging 60 to dissipate heat produced by the prismatic battery cells 30 during operation of the battery module 14.

It may be appreciated that using a conformal restraining medium 70 ensures that the restraining medium is in good thermal contact with a substantial portion of the surface of the packaging 32 of each prismatic battery cell 30 and with the battery module packaging 60, which may improve thermal transfer between the prismatic battery cells 30 and the aforementioned heat sink feature. In certain embodiments, the restraining medium may also be useful to absorb gases (e.g., CO₂) and heat that may be released if one or more of the prismatic battery cells 30 undergoes a thermal event.

With these design considerations in mind, in certain embodiments, the restraining medium 70 may be substantially polymeric and may include one or more additives to provide the above-mentioned properties. For example, in certain embodiments, the restraining medium 70 may be an epoxy-based or a silicone-based restraining medium 70 that may be impregnated with metal (e.g., aluminum powder) or carbon particles to enhance thermal conductivity of the medium 70. In certain embodiments, the restraining medium 70 may be formed from one or more restraining medium precursor materials that may solidify upon curing to form the restraining medium 70. For example, in certain embodiments, the restraining medium 70 may be formed from a two-part epoxy resin that only begins to solidify after both parts have been mixed together. In certain embodiments, one or more restraining medium precursor materials may cure and solidify in response to heat, light, or mixing time to form the restraining medium 70. In certain embodiments, the restraining medium precursor may be a liquid, solid, gel, powder, pellets, or a suitable compressed material (e.g., ceramic) that may be formed into the restraining medium 70 via curing, cross-linking, sintering, finishing, or another suitable solidification or finishing method.

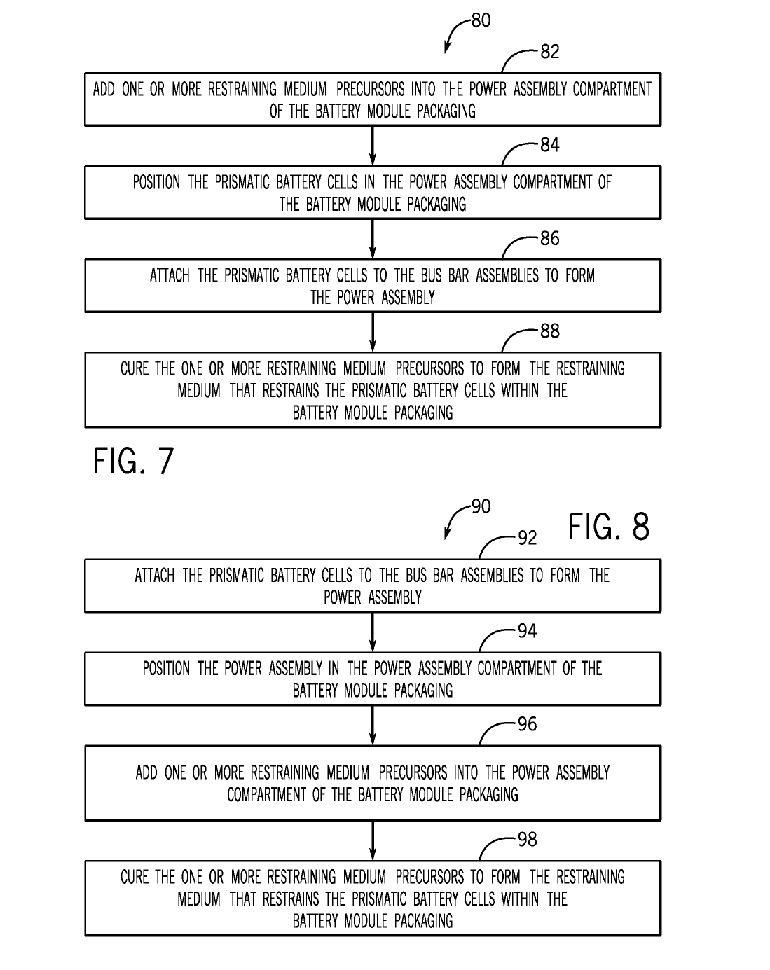

FIGS. 7 and 8 illustrate example embodiments of methods for manufacturing the battery module 14 of the present approach. In particular, FIG. 7 illustrates an embodiment of a method 80 that begins with adding (block 82) one or more restraining medium precursors to the battery module packaging 60. For example, one or more restraining medium precursors may be added to a particular level within the power assembly compartment 64 of the battery module packaging 60.

Then, since the one or more restraining medium precursors are still malleable, flowable, etc., the prismatic battery cells 30 may each be positioned (block 84) within the power assembly compartment 64 of the battery module packaging 60. In this regard, it should be noted that the acts represented by block 84 may include filling the power assembly compartment 64 to a particular level that accounts for an expected volume range of the prismatic battery cells 30. Further, it should be noted that certain acts represented by blocks 82 and 84 may be performed to account for manufacturing variability. For instance, additional restraining medium precursors may be provided to the power assembly compartment 64 after the cells are placed in the power assembly compartment 64, until a desired fill level is reached.

Subsequently, the prismatic battery cells 30 may be attached (block 86) to the bus bar assemblies 50 and 52, for example, using laser welding to weld the terminals 40, 42 of the prismatic battery cells 30 to the bus bars 56 of the bus bar assemblies 50 and 52. For example, the prismatic battery cells 30 may be fitted with the bus bar assemblies 50 and 52, and the bus bars 56 may be appropriately positioned and secured to the prismatic battery cells 30.

Then, the one or more restraining medium precursors may be cured (block 88) to form the restraining medium 70. The curing (or other finishing/hardening step) results in the formation of the restraining medium 70, and individually secures and restrains each prismatic battery cell 30 of the battery module 14.

It should be noted that the order of certain of the acts described above with respect to FIG. 7 may be performed in different orders, depending, for example, the expected robustness of the power assembly and the nature of the restraining medium and/or its precursors. Method 90 illustrated in FIG. 8, for instance, begins with each of the prismatic battery cells 30 first being attached (block 92) to the bus bar assemblies 50 and 52. Again, this may include using laser welding or any other appropriate securement method to form the power assembly 48.

Then, the power assembly 48 may be positioned (block 94) within the power assembly compartment 66 of the battery module packaging 60. Subsequently, one or more restraining medium precursors may be added (block 96) to the power assembly compartment 66 of the battery module packaging 60. In other embodiments, the one or more restraining medium precursors may be added to the power assembly compartment 66 before the power assembly 48 is positioned within the power assembly compartment 66. Then, the one or more restraining medium precursors may be cured (block 88) to form the restraining medium 70, which individually secures and restrains each prismatic battery cell 30 of the battery module 14. It may be appreciated that the method 90 illustrated in FIG. 8 may be advantageous over other methods of manufacturing in that various laser welding operations (e.g., of the terminals to the bus bars) may take place away from the one or more restraining medium precursors.

It may be appreciated that, in certain embodiments, one or more additional steps may be performed to enhance the effectiveness of the present approach. For example, as mentioned above, prismatic battery cells 30 may swell during charging and shrink while discharging when not properly restrained. With this in mind, in certain embodiments, the prismatic battery cells 30 of a battery module 14 may be substantially discharged before the restraining medium is cured to ensure that the prismatic battery cells 30 are at their minimum relative size (e.g., have a minimum thickness 46) before the restraining medium 70 is solidified around them.

By way of non-limiting example, in certain embodiments, the prismatic battery cells 30 may be discharged to a level below their rated minimum state of charge (SOC) to ensure that the prismatic battery cells 30 are smaller (e.g., minimum thickness 46) than they will ever be during normal operation of the battery module 14. For instance, if the prismatic battery cells 30 are expected to be operated at a minimum SOC of 25%, such operations may discharge the cells 30 to a lower SOC, for example 20%, 15%, 10%, or the like.

In other embodiments, prior to curing the one or more restraining medium precursors, the battery module may be agitated (e.g., shaken, rocked, sonicated) to remove any extraneous air bubbles from the precursors to prevent the formation of voids in the restraining medium 70 after curing. Alternatively, voids may be intentionally created in the restraining medium 70, for example by introducing breakable, hollow blocks or the like, to enable the prismatic battery cells 30, in a thermal runaway event that generates sufficient force, to deform the restraining medium 70 into the intentionally created void to uptake at least some of the force and thereby potentially reduce damage to the battery module 14.

Additionally, in certain embodiments, other components of the battery module 14 (e.g., relays, control circuitry) may be similarly restrained within the restraining medium 70 at the same time as the prismatic battery cells 30 for enhanced efficiency. It may be appreciated that in such embodiments, the restraining medium 70 would be of a sufficient dielectric level to avoid shorting. Further, the restraining medium 70 may also provide some level of interference control and insulation.

The technical effects of the present disclosure include the manufacture of battery modules having individually restrained battery cells. The disclosed designs enable the use of a conformal restraining medium formed at the time of manufacturing that individually restrains the battery cells into position within the packaging of the battery module. The disclosed battery module designs enable greater variability in the dimensions of each battery cell of a module, providing greater flexibility to select a set of battery cells for installation in a battery module based on particular electrical and thermal considerations, without having to worry about the exact dimensions of each battery cell relative to battery module packaging. Additionally, the disclosed restraining medium individually prevents each of the battery cells from substantially swelling during operation, improving performance of the battery cells over the lifetime of the battery module. Further, the restraining medium may electrically insulate the battery cells as well as promote battery cell cooling during operation of the battery module. Accordingly, the disclosed battery module designs offer improved flexibility and performance compared to other battery module designs.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A battery module, comprising:
a battery module packaging;
a plurality of lithium ion battery cells disposed within the battery module packaging; and
a restraining medium conformally coated about each lithium ion battery cell of the plurality of lithium ion battery cells;
wherein each lithium ion battery cell of the plurality of lithium ion battery cells is individually held in place within the battery module packaging by the restraining medium, and the restraining medium is configured to resist expansion of the plurality of lithium ion battery cells during operation.

2. The battery module of claim 1, wherein the restraining medium is disposed about two faces of each lithium ion battery cell of the plurality of lithium ion battery cells.

3. The battery module of claim 1, wherein the plurality of lithium ion battery cells comprises lithium ion battery cells having different thicknesses.

4. The battery module of claim 1, wherein the plurality of lithium ion battery cells comprises prismatic battery cells.

5. The battery module of claim 1, wherein a cathode active material of the plurality of lithium ion battery cells comprises lithium nickel manganese cobalt oxide (NMC).

6. The battery module of claim 5, wherein a cathode active material of the plurality of lithium ion battery cells comprises lithium cobalt oxide (LCO) blended together with the NMC.

7. The battery module of claim 1, wherein an anode active material of the plurality of lithium ion battery cells comprises lithium titanate (LTO).

8. The battery module of claim 1, comprising a first bus bar assembly and a second bus bar assembly that electrically couple the plurality of lithium ion battery cells.

9. The battery module of claim 8, wherein the first and second bus bar assemblies define a uniform terminal-to-terminal distance between each of the plurality of lithium ion battery cells.

10. The battery module of claim 1, wherein the restraining medium is electrically insulative.

11. The battery module of claim 1, wherein the restraining medium is thermally conductive.

12. The battery module of claim 1, wherein the restraining medium comprises an epoxy resin.

13. The battery module of claim 1, comprising a heat sink disposed on a bottom side of the battery module opposite a top side of the battery module positioned proximate a set of terminals of the plurality of lithium ion battery cells, wherein the restraining medium is in thermal contact with the plurality of lithium ion battery cells and with the heat sink.

14. A battery module, comprising:
a battery module packaging;
a plurality of prismatic battery cells disposed within the battery module packaging, wherein each prismatic battery cell comprises a top portion having terminals, a bottom portion opposite the top portion, and side portions extending between the top and bottom portions; and
a restraining medium conformally coated about the bottom portion and the side portions, the side portions being conformally coated by the restraining medium such that the restraining medium encompasses an expected swell region of the side portions;
wherein each prismatic battery cell of the plurality of prismatic battery cells is individually held in place within the battery module packaging by the restraining medium.

15. The battery module of claim 14, wherein the expected swell region corresponds to a position of an electrode jelly roll of each prismatic battery cell.

16. The battery module of claim 14, comprising a first bus bar assembly and a second bus bar assembly that electrically couple the plurality of prismatic battery cells.

17. The battery module of claim 16, wherein the first and second bus bar assemblies define a uniform terminal-to-terminal distance between each of the plurality of prismatic battery cells.

18. A method of manufacturing a battery module, comprising:
coupling a plurality of battery cells to a bus bar assembly such that respective terminal pairs of each battery cell of the plurality of battery cells are spaced apart from an adjacent terminal pair of an adjacent battery cell of the plurality of battery cells at a fixed distance;
disposing the plurality of battery cells and the bus bar assembly into a battery module packaging;
disposing a restraining medium precursor inside the battery module packaging; and
curing the restraining medium precursor to form a restraining medium that holds the plurality of battery cells in position within the battery module packaging.

19. The method of claim 18, comprising discharging the plurality of battery cells before coupling the plurality of battery cells to the bus bar assembly.

20. The method of claim 19, wherein discharging the plurality of battery cells before coupling the plurality of battery cells to the bus bar assembly comprises discharging the plurality of battery cells to a state of charge (SOC) below a minimum rated SOC for the plurality of battery cells.

21. The method of claim 18, wherein the restraining medium precursor comprises a part of a two-part epoxy resin.

22. The method of claim 18, comprising disposing an additional restraining medium precursor or a curing agent in the battery module packaging before curing the restraining medium precursor to form the restraining medium.

23. The method of claim 18, comprising coupling the plurality of battery cells to an additional bus bar assembly.

24. The method of claim 18, wherein the plurality of battery cells and the bus bar assembly are disposed into the battery module packaging before the restraining medium precursor.

25. The method of claim 18, wherein the plurality of battery cells and the bus bar assembly are disposed into the battery module packaging after the restraining medium precursor.
